(19) United States
(12) Patent Application Publication
(10) Pub. No.: US 2012/0173193 A1
(43) Pub. Date: Jul. 5, 2012

(54) MEASUREMENT APPARATUS

(75) Inventors: CHIH-KUANG CHANG, Tu-Cheng (TW); SHENG-QIANG SHEN, Shenzhen City (CN); ZHI-HUI LUO, Shenzhen City (CN); PING HE, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD, Shenzhen City (CN)

(21) Appl. No.: 13/211,756

(22) Filed: Aug. 17, 2011

(30) Foreign Application Priority Data
Dec. 31, 2010 (CN) 201010618484.8

(51) Int. Cl. G06F 15/00; G01B 5/004

(52) U.S. Cl. 702/150; 33/503

(57) ABSTRACT

A measurement apparatus includes a platform, a base, and an observation unit. The base is slidably mounted on the platform. The observation unit is slidably mounted on the base. The observation unit comprises an image measurement assembly and a contact measure assembly. The image measure assembly measures an object supported on the platform using the image measurement assembly. The contact measurement assembly can be used to measure the object by direct contact.

### BACKGROUND

1. Technical Field

The present disclosure relates to measurement apparatuses, particular to a measurement apparatus for measuring an object.

2. Description of Related Art

An image measurement apparatus is often applied to measure workpieces. The image measurement apparatus includes an observation unit, a base, a console, a platform, a display device, and a computer. The image measurement apparatus measures workpieces by measuring images of the workpieces captured by the observation unit. However, the base, the console, the platform, the display device, and the computer are usually in fixed positions, so the image measurement apparatus is not so easily used for measuring workpieces of different sizes and shapes. For example, when the workpiece has an irregular shape, it may be that a portion of the workpiece to be measured cannot be reached by light sent from the observation unit, and some other means of measurement must be employed, which is inconvenient and can add to the cost of manufacture. What is needed, therefore, is another pressing apparatus to overcome the limitations described.

### BRIEF DESCRIPTION OF THE DRAWINGS

FIG. 1 is a perspective view of one embodiment of a measurement apparatus including a computer and a display device.

FIG. 2 is an enlarged view of a circled portion II of FIG. 1.

FIG. 3 is a front view of the measurement apparatus of FIG. 1 without the computer and display.

FIG. 4 is similar to FIG. 3 but a rear view of the measurement apparatus of FIG. 1.

### DETAILED DESCRIPTION

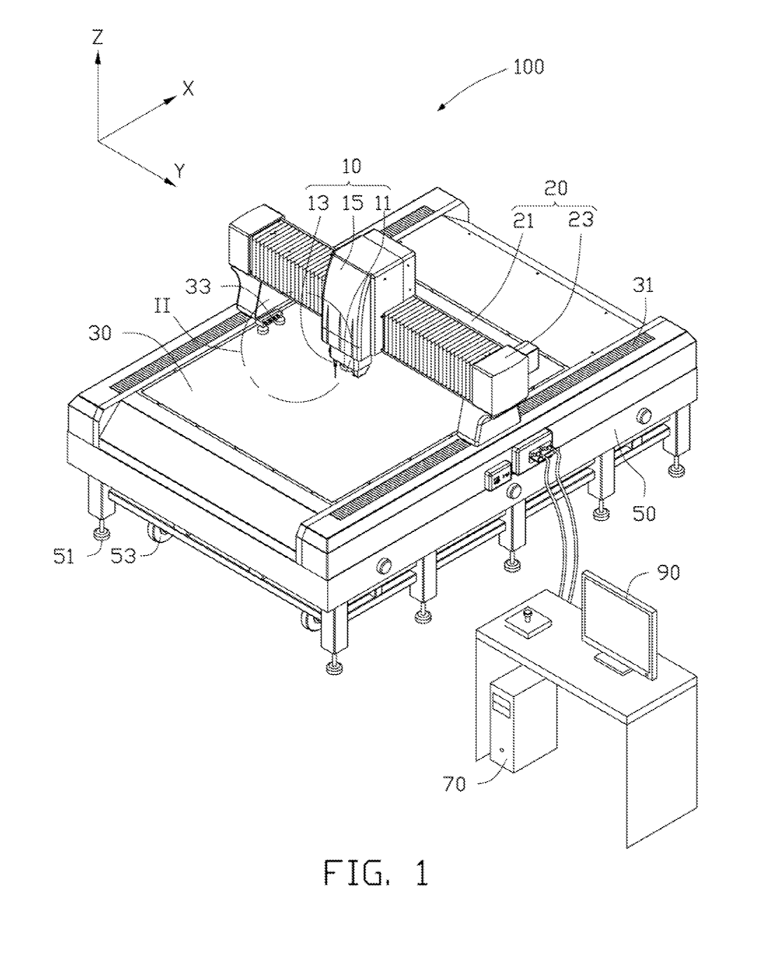

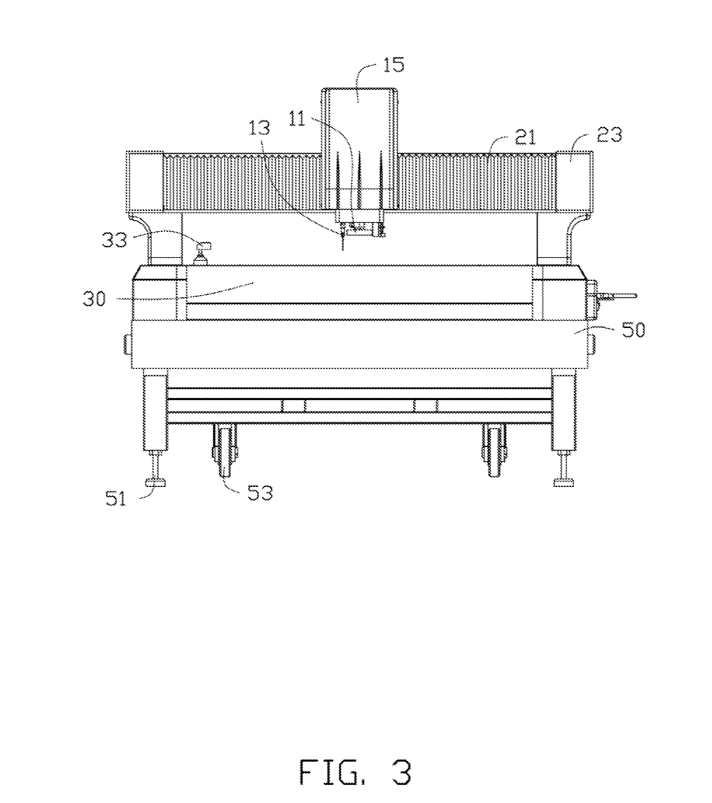

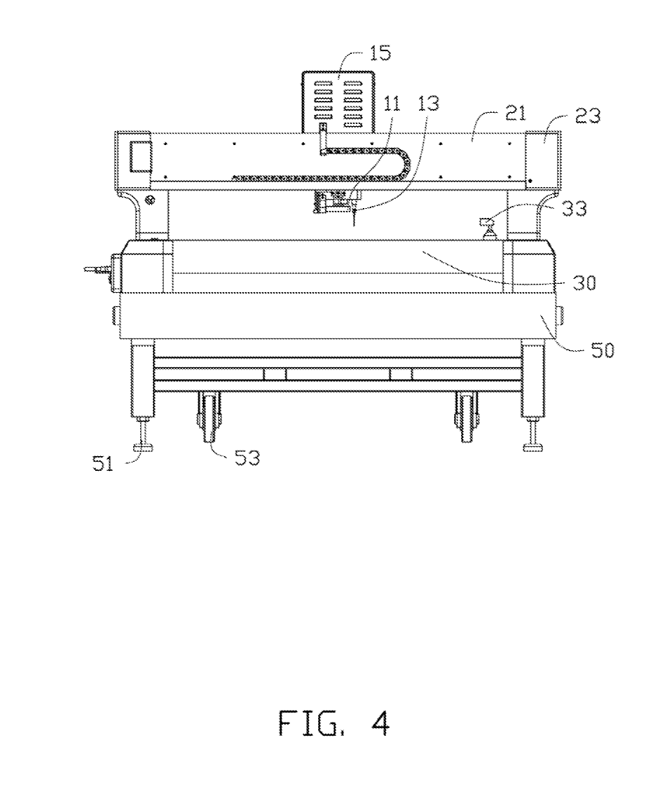

FIGS. 1-4 show a measurement apparatus 100 used to measure dimensions of an object. The object may be a workpiece, an electronic component, or a mechanical component, for example. The measurement apparatus 100 includes an observation unit 10, a movable base 20, a platform 30 configured to support the object (not shown), a console 50, a computer 70, and a display device 90. Both the observation unit 10 and the platform 30 are electrically connected to the computer 70 and the display device 90 by the console 50. The observation unit 10 is slidably mounted on the movable base 20. The movable base 20 is a bridge-link structure slidably mounted on the platform 30. The observation unit 10 includes an image measure assembly 11 and a contact measure assembly 13. The apparatus 100 can measure the object on the platform 30 by the image measure assembly 11 or/and the contact measure assembly 13. The console 50 transmits the data measured by the observation unit 10 to the computer 70 and the display device 90, to calculate and display the result.

The observation unit 10 is configured to measure dimensions of the object, which further includes a main body 15. The main body 15 which mounts on the base 20, is configured to support both the image measure assembly 11 and the contact measure assembly 13.

Both the image measure assembly 11 and the contact measure assembly 13 are fixed at the same end of the main body 15, so that both can face the platform 30. The image measure assembly 11 is configured to determined measurements of the object by measuring images of the object, and the contact measure assembly 13 is configured to measure the object by direct contact measurement. In addition, both the image measure assembly 11 and the contact measure assembly 13 are movable relative to the main body 15 along a Z-axis of the platform 30 to be nearer to or further away from the object. And in this exemplary embodiment, the maximum range of movement of both the image measure assembly 11 and the contact measure assembly 13 relative to the main body 15 is approximately 300 mm.

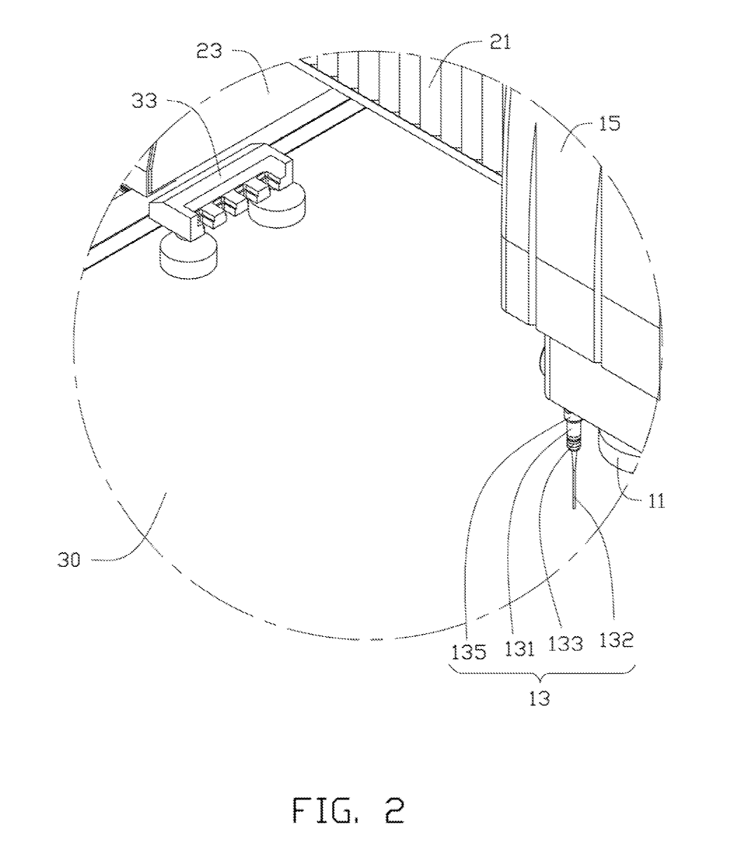

Also referring to the FIG. 2, the contact measure assembly 13 includes a base portion 131, a probe 132, a sensor 133, and a encode module 135. The base portion 131 is mounted on the main body 15. The probe 132, the sensor 133, and the encode module 135 are mounted on the base portion 131, and the probe 132 faces the platform 30. The probe 132 is operated to move towards the object on the platform 30. When the probe 132 contacts the object, the probe 132 can feedback a signal to the sensor 133. As soon as the sensor 133 receives the signal, the probe 132 is stopped by the sensor 133. Thereafter the sensor 133 measures position of the probe 132, and sends the position data of the probe 132 to the encode module 135. The encode module 135 encodes the position data so that it can be read by the computer 70, and sends the encoded data to the computer 70.

The base 20 includes a crossbeam 21 and two sliding portions 23. The two sliding portions 23 are perpendicularly extended from the two opposite ends of the crossbeam 21. The crossbeam 21 is parallel to a Y-axis of the platform 30, so that the main body 15 can slide on the crossbeam 21 along the Y-axis of the platform 30. The two sliding portions 23 are mounted on the platform 30, and can slide along an X-axis of the platform 30. In this exemplary embodiment, the maximum range of movement of both the body 20 and the observation unit 10 on the body 20 along the Y-axis of the platform 30 is approximately 1500 mm, and the maximum range of movement of both the body 20 and the observation unit 10 along the X-axis of the platform 30 is approximately 1200 mm.

The platform 30 includes a pair of tracks 31 mounted on two sides of the platform 30. The tracks 31 are parallel to the X-axis of the platform 30, and are configured to slidably support the sliding portions 23 along the X-axis of the platform 30. The platform 30 further includes a probe support 33, which can hold different sizes of probes (not shown) according to the object to be measured. The platform 30 further includes at least three raster scales (not shown) operable to measure location of the image measure assembly 11, the contact measure assembly 13, and the base 20 for the computer 70. As a result, the computer 70 may precisely calculate movements of the observation unit 10, and the base 20.

The console 50 communicates with both the computer 70 and the display device 90 through cables. The console 50 includes at least one support 51 and at least one moving element 53. The at least one support 51 is operable to support the apparatus 100 and the at least one moving element 53 is operable to move the apparatus 100. In the embodiment, the at least one moving element 53 is a wheel. The at least one support 51 is a telescopic mechanism which may be lengthened and shortened.

The computer 70 is configured to control the apparatus 100 to start measuring the object. The computer 70 is capable of storing the image captured by the image measure assembly 11, when the apparatus 100 measures objects by the image measure assembly 11. The computer 70 is further capable of drawing a curve representing position data points of the probe 132, when the apparatus 100 measures objects by contact measure assembly 13, and the probe 132 contacts the object at different sample points of a predetermined path. The display device 90 is capable of displaying an operating interface according to the computer 70, and showing the image stored by the computer 70, and the curve drawn by the computer 70. A mouse and a keyboard (not shown) system may also be employed. Thereafter an operator can select a specified portion of the image or the curve, and software in the computer 70 will calculate dimensions, flatness, and/or other parameters of the selected portion, and the results can appear on the display device 90.

There are two different ways to use the apparatus 100 to measure an object provided below.

One way is image measurement, according to steps provided below: First, the observation unit 10 is operated to move along the X-axis and/or the Y-axis of the platform 30, until the image measure assembly 11 is aimed at the object on the platform 30. Second, the image measure assembly 11 is operated to capture images of the object, and send the images to the computer 70. Third, the computer 70 receives and stores the images, and displays the images on the display device 90. Fourth, an operator selects a specific portion of the object to be measured. Fifth, the computer 70 calculates dimensions, flatness, and/or other parameters of the selected portion. Finally, the display device 90 shows the result calculated by the computer 70.

Another way is contact measurement, according to steps provided below: First, the observation unit 10 is operated to move along the X-axis and/or the Y-axis of the platform 30, until the probe 132 is aimed at the object on the platform 30. Second, the probe 132 is operated to move along a predetermined path on the object 132, so that the probe 132 can touch the object at predetermined sample points. Third, the sensor 133 measures the position of the probe 132 at each sample point, such as the position on the coordinate axis of the platform 30, and sends the position data to the encode module 135. Fourth, the encode module 135 encodes the position data to signal that can be read by the computer 70, and sends the signal to the computer 70. Fifth, the computer 70 receives the signal, and draws a curve correspondingly. Sixth, the computer 70 displays the curve on the display device 90. Seventh, an operator selects a specific portion of the curve according to the portion to be measured of the object. Eighth, the computer 70 calculates the dimension, flatness, and/or other parameters of the selected measuring portion of the curve shown on the display device 90. Finally, the display device 90 displays the result calculated by the computer 70.

The observation unit 10, the base 20, and the platform 30 are arranged in a bridge-like structure and so can be adjusted to accommodate and measure objects of different size and shape. And to further enhance such ability, the apparatus 100 is equipped to either use image measurement, or contact measurement so that no other equipment need be employed to measure an object, even if the shape is irregular.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A measurement apparatus, comprising:
a platform;
a base slidably mounted on the platform;
an observation unit slidably mounted on the base, comprising:
an image measure assembly configured to determine measurements of object supported on the platform by measuring images of the object; and
a contact measure assembly configured to measure the object by direct contact measurement.

2. The measurement apparatus of claim 1, wherein the observation unit further comprises a main body mounted on the base, both the image measure assembly and the contact measure assembly are mounted on the main body, and both can move relative to the observation unit along a Z-axis of the platform.

3. The measurement apparatus of claim 1, wherein the platform comprises a pair of tracks paralleled to an X-axis of the platform, the base includes two sliding portions slidably mounted on the tracks.

4. The measurement apparatus of claim 1, wherein the base further comprises a crossbeam connected to the two sliding portions, and the crossbeam is paralleled to a Y-axis of the platform, the observation unit slides on the crossbeam along the Y-axis of the platform.

5. The measurement apparatus of claim 1, wherein the observation unit connects to the platform in a bridge-link structure by the base.

6. The measurement apparatus of claim 1, further comprising a computer and a display device electronically connected to the observation unit, the computer is capable of storing data measured by the observation unit, and calculating the result according to the data, the display device is capable of displaying an operating interface according to the computer, and showing the result calculated by the computer.

7. The measurement apparatus of claim 6, wherein the contact measure assembly comprises a probe and a sensor, the probe is configured to move in a predetermined path on the object, and feedback a signal to the sensor when the probe touch the object at each sample point, the sensor stops the probe after receiving the signal, and measures position of the probe in each sample point, thereafter sends the position data of different sample points to the computer.

8. The measurement apparatus of claim 7, wherein the contact measure assembly further comprises an encode module electronically connected to the computer and the sensor, which is configured to encode the position data into signal that can be read by the computer, and transmits the signal to the computer.

9. The measurement apparatus of claim 8, wherein the computer is capable of drawing a curve according to the position data of the probe in each sample point, and calculate dimensions, flatness, or other parameters of a selected portion in the curve.

10. The measurement apparatus of claim 6, further comprising a console configured to control the observation unit to measure object, and connect the observation unit to the computer.

11. The measurement apparatus of claim 10, wherein the console further comprises at least one moving element operable to move the measurement apparatus.

12. The measurement apparatus of claim 10, wherein the console further comprises at least one support operable to support the measurement apparatus.

13. The measurement apparatus of claim 12, wherein the at least one support is a telescopic mechanism.
